(19) United States
(12) Patent Application Publication
(10) Pub. No.: US 2013/0015228 A1
(43) Pub. Date: Jan. 17, 2013

(54) Method and Apparatus for Breaking a Web Using a Cut-off Assembly

(71) Applicants: Frank Stephen Hada, Appleton, WI (US); James Leo Baggot, Menasha, WI (US); Matthew Robert Wilson, Oshkosh, WI (US); Robert Eugene Krautkramer, Combined Locks, WI (US); Kyle Andrew Krautkramer, Kaukauna, WI (US)

(72) Inventors: Frank Stephen Hada, Appleton, WI (US); James Leo Baggot, Menasha, WI (US); Matthew Robert Wilson, Oshkosh, WI (US); Robert Eugene Krautkramer, Combined Locks, WI (US); Kyle Andrew Krautkramer, Kaukauna, WI (US)

(21) Appl. No.: 13/183,584

(22) Filed: Jul. 15, 2011

(51) Int. Cl. B65H 35/10; B26F 3/00

(52) U.S. Cl. 225/4; 225/101

(57) ABSTRACT

A cut-off method and apparatus capable of breaking a moving web is disclosed herein. The cut-off method and apparatus include a conveying surface over which a moving web is conveyed and a web cut-off assembly opposing the conveying surface. The web cut-off assembly includes a first arm with a first web gripping surface and a second arm with a second web gripping surface, the first and second web gripping surfaces being movable relative to one another. To complete a breaking event, the first and second web gripping surfaces contact the moving web at a first contact point and second contact point. The contact points move from a first spaced apart relationship to a second spaced apart relationship causing a break in the web between the first and second web gripping surfaces.

### BACKGROUND

Winders are machines that roll lengths of paper, commonly known as paper webs, into logs. Winders are capable of rolling lengths of web into logs at high speeds through an automated process. Turret winders are well known to those skilled in the art. Conventional turret winders contain a rotating turret assembly which supports a plurality of mandrels for rotation about a turret axis. The mandrels travel in a circular path at a fixed distance from the turret axis. The mandrels engage hollow cores upon which a paper web can be wound. Typically, the paper web is unwound from a parent roll in a continuous fashion, and the turret winder rewinds the paper web onto the cores supported on the mandrels to provide individual, relatively small diameter logs. The rolled product log is then cut to designated lengths into the final product. Final products typically created by these machines and processes are toilet tissue rolls, paper toweling rolls, paper rolls, and the like.

The winding technique used in turret winders is known as center winding. A center winding apparatus, for instance, is disclosed in U.S. Pat. Reissue No. 28,353 to Nystrand, which is incorporated in its entirety herein by reference. In center winding, a mandrel is rotated in order to wind a web into a roll/log, either with or without a core. Typically, the core is mounted on a mandrel that rotates at high speeds at the beginning of a winding cycle and then slows down as the size of the rolled product being wound increases, in order to maintain a constant surface speed, approximately matching web speed. Center winders work well when the web that is being wound has a printed, textured, or slippery surface. Also, typically, center winders are preferable for efficiently producing soft-wound, higher bulk rolled products.

A second type of winding is known to those skilled in the art as surface winding. A machine that uses the technique of surface winding is disclosed in U.S. Pat. No. 4,583,698. Typically, in surface winding, the web is wound onto the core via contact and friction developed with rotating rollers. A nip is typically formed between two or more co-acting roller systems. In surface winding, the core and the web that is wound around the core are usually driven by rotating rollers that operate at approximately the same speed as the web speed. Surface winding is preferable for efficiently producing hard-wound, lower bulk rolled products.

A problem found in both center and surface winders involves the winder shutting down when a condition such as a web break fault occurs. A web break fault occurs when a rolled product needs to be cut at a predetermined length for manufacture of a subsequent rolled product, and the web fails to break and causes wrinkling, folding or otherwise falling out of alignment. For example, one current web breaking apparatus includes two rotary paddles that are brought up to speed at transfer as referenced in U.S. Pat. No. 7,909,282 to Wojcik et al., which is incorporated in its entirety by reference. The paddles contact a moving web at different speeds and create strain, breaking the sheet at the perforation. The problem with this method is that the paddles are relatively far apart so the length of sheet between the paddles is longer than a sheet length on bathroom tissue. Occasionally, the sheet will break at the wrong perforation line, or at different perforation lines along the length of the cut. An additional problem is that the strain to create a break in the sheet is large requiring a great amount of extension in the sheet. Paddles need to be accelerated within one revolution which requires high torque and can limit the maximum speed of the machine.

A web break fault in a center or surface winder will result in shutting the machine down. This results in a production loss and the immediate requirement to obtain repair services. Thus, there is a need to provide an apparatus and method that reduces the number of web break faults.

### SUMMARY

A web cut-off system and method capable of breaking a moving web for use with the manufacture of a rolled product is disclosed. The cut-off system and method include a conveying surface over which a moving web is conveyed and a web cut-off assembly opposing the conveying surface. The web cut-off assembly includes a first arm with a first web gripping surface and a second arm with a second web gripping surface, the first and second web gripping surfaces being movable relative to one another. To complete a breaking event, the first and second web gripping surfaces contact the moving web at a first contact point and a second contact point. The contact points move from a first spaced apart relationship to a second spaced apart relationship causing a break in the web between the first and second contact points.

Furthermore, the web cut-off assembly may be an integrated assembly wherein the two arms are attached and move together to contact the web. An integrated assembly provides easy control of the mechanism to provide more consistent and effective breaking of the web. The web cut-off assembly may also be moved radially within the web cut-off roll to contact the moving web and causing the first web gripping surface and the second web gripping surface to contact the moving web simultaneously.

The conveying surface of the web may be a bedroll that rotates with the moving web. In exemplary embodiments, the conveying surface may be a vacuum roll that holds a moving web onto the conveying surface. In exemplary embodiments, the conveying surface further comprises a first sliding support portion and a second sliding support portion, the first sliding support portion and the second sliding support portion are movable relative to each other, wherein the first sliding support portion and the second sliding support portion move away from each other when the cut-off assembly contacts the moving web.

The short length of the first spaced part relationship allows for efficient and effective breaking and severing over a wide range of web properties and processing conditions. In particular, the web is only under tension in between the two web gripping points of the arms which prevents the moving web from wrinkling, folding or otherwise falling out of alignment. The short distance between the gripping elements requires a short amount of strain to reach the breaking point of the web ensuring that the break is in the desired location. Desirably, the first spaced apart relationship is less than about 8 cm, and more desirably from about 2.5 cm to about 5 cm.

To enable the cut-off assembly to cause the moving web to break, the first and second web gripping surfaces have a gripping surface coefficient of friction to the web greater than a conveying surface coefficient of friction to the web.

### BRIEF DESCRIPTION

A full and enabling disclosure thereof, directed to one of ordinary skill in the art, is set forth more particularly in the remainder of the specification, which makes reference to the appended figures in which:

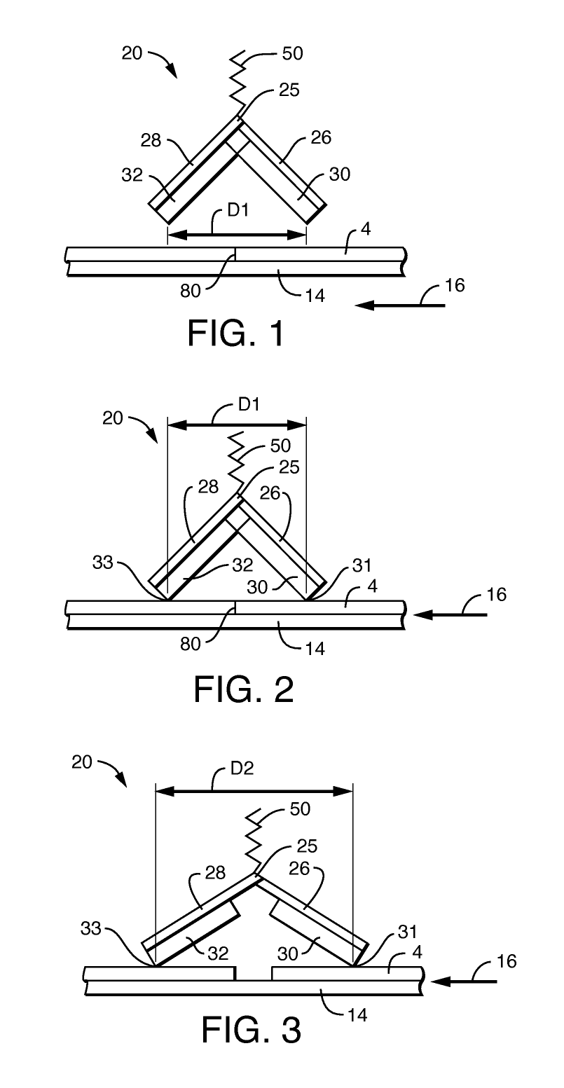

FIG. 1 illustrates an exemplary web cut-off assembly.

FIG. 2 illustrates the exemplary web cut-off assembly of FIG. 1 in the engagement position.

FIG. 3 illustrates the exemplary web cut-off assembly of FIG. 1 in the web-breaking position.

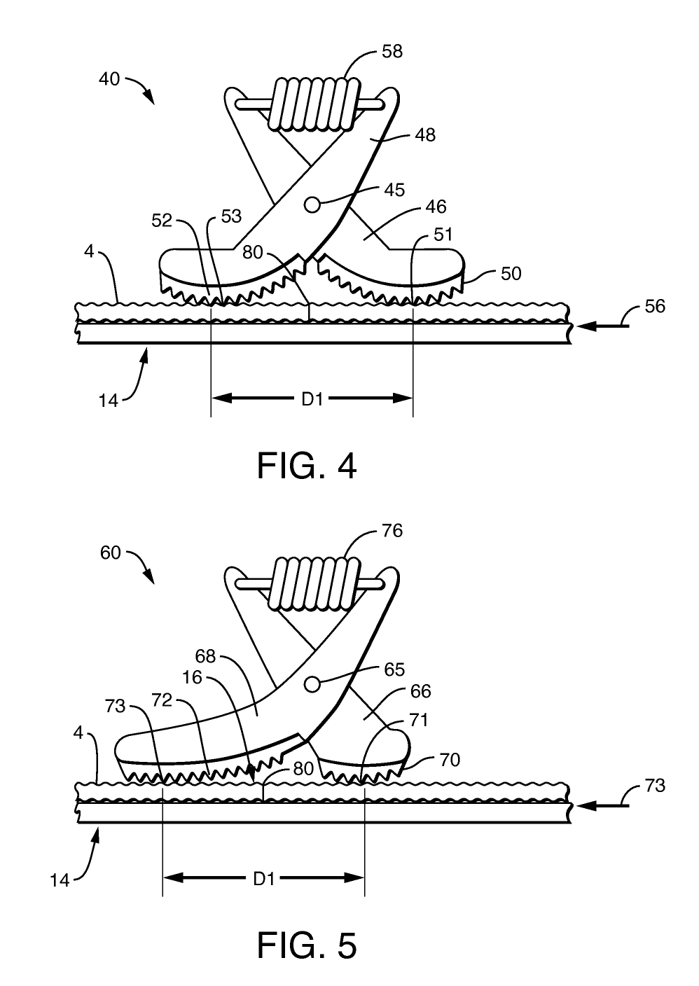

FIG. 4 illustrates an alternative web cut-off assembly.

FIG. 5 illustrates another alternative web cut-off assembly.

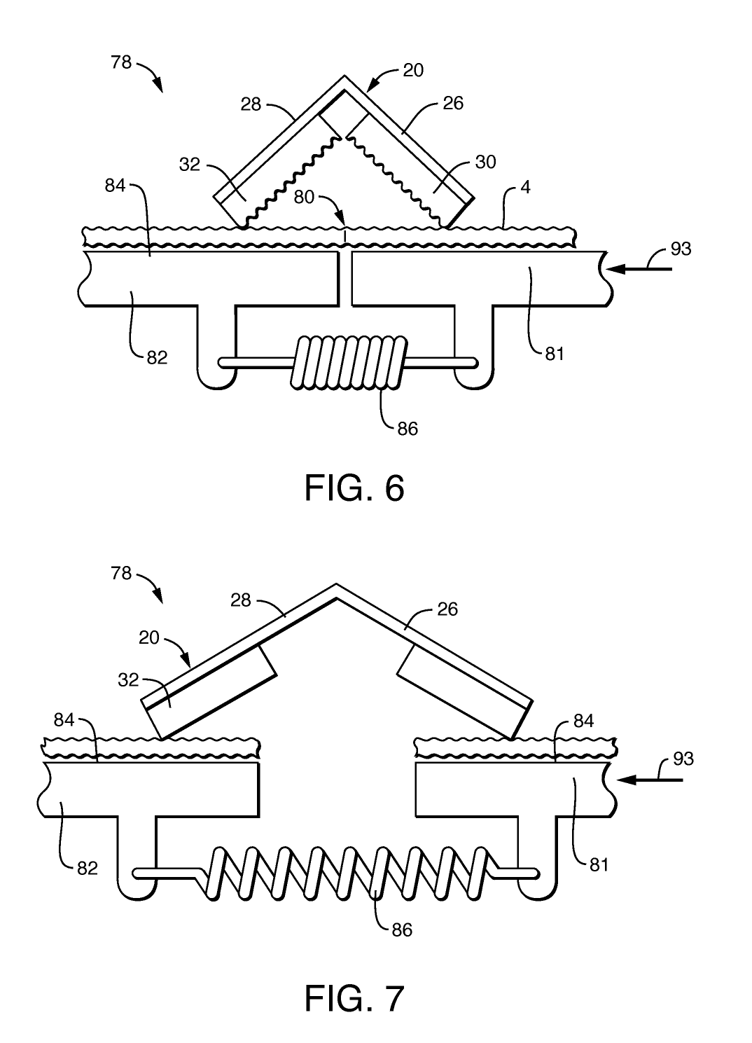

FIG. 6 illustrates yet another alternative web cut-off assembly.

FIG. 7 illustrates the web cut-off assembly of FIG. 6 in the web-breaking position.

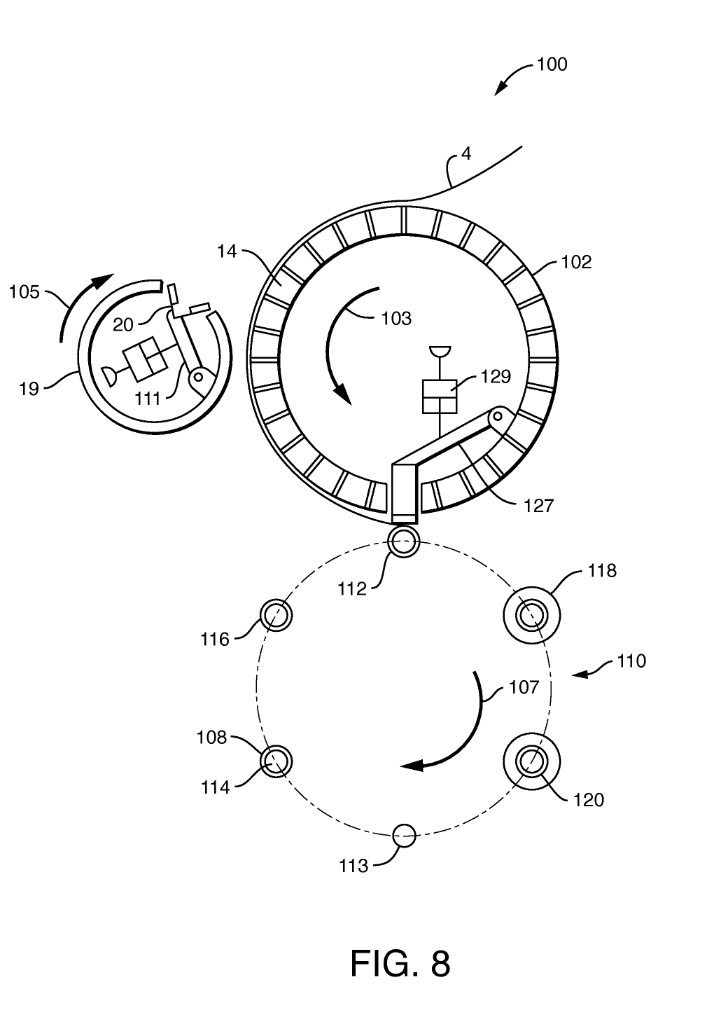

FIG. 8 illustrates the exemplary web cut-off assembly of FIG. 1 in use with a turret winder.

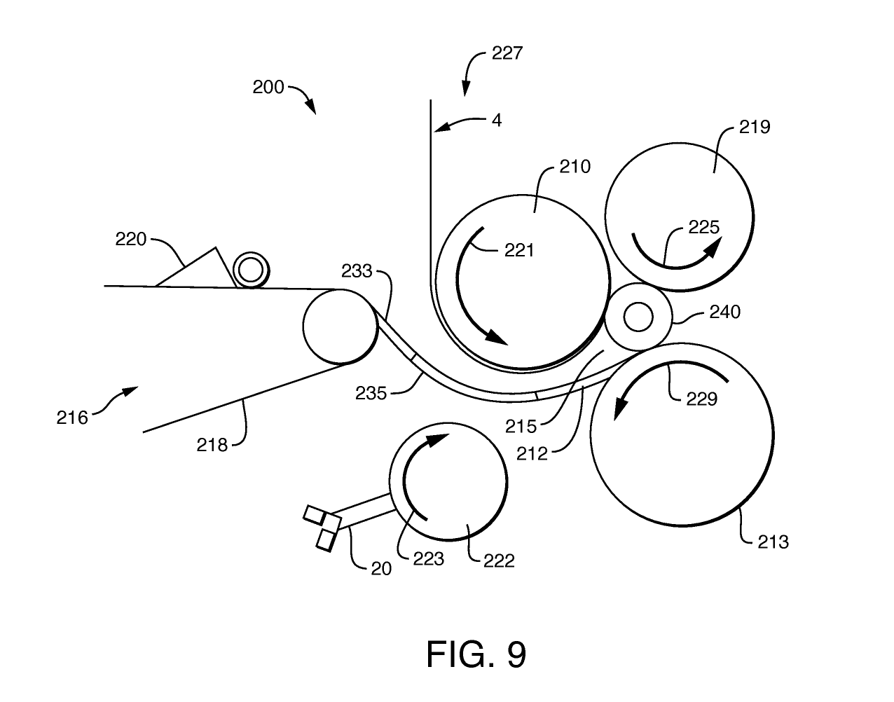

FIG. 9 illustrates the exemplary web cut-off assembly of FIG. 1 in use with a surface winder.

### DETAILED DESCRIPTION

Reference now will be made in detail to various embodiments of the invention, one or more examples of which are set forth below. Each example is provided by way of explanation, not limitation. In fact, it will be apparent to those skilled in the art that various modifications and variations may be made in the present disclosure without departing from the scope or spirit of the claims. For instance, features illustrated or described as part of one embodiment, may be used on another embodiment to yield a still further embodiment. Thus, it is intended that the claims cover such modifications and variations.

As described above, as moving webs of material are manufactured into a rolled product on various types of winders, the moving web needs to be broken to allow for manufacture of a subsequent rolled product. A web cut-off method and apparatus capable of breaking a moving web is disclosed herein. The web cut-off method and apparatus include a conveying surface over which a moving web is conveyed and a web cut-off assembly opposing the conveying surface. The web cut-off assembly includes a first arm with a first web gripping surface and a second arm with a second web gripping surface, the first and second web gripping surfaces being movable relative to one another. To complete a breaking event, the first and second web gripping surfaces contact the moving web and move from a first spaced apart relationship to a second spaced apart relationship causing a break in the web between the first and second web gripping surfaces.

The web cut-off assembly described herein can provide various advantages and benefits. For instance, by using two web gripping surfaces within the web cut-off assembly, the web can be efficiently and effectively broken and severed over a wide range of web properties and processing conditions. In addition, the two arms as described above place tension only on a short length of the web during the break. In particular, the web is only under tension in between the two web gripping points of the arms which prevents the moving web from wrinkling, folding or otherwise falling out of alignment. The cut-off assembly also provides web control upstream and downstream from the cut-off edge, which minimizes slack in the web in the winding roll that is being finished as well as in the leading portion of the new web for the new roll to be wound. The apparatus also prevents the web from sliding upstream and enables a robust break at high or low speed and at high or low web tension. An additional benefit is that the natural compression of the web cut-off assembly will serve to hold the web and cause the strain of the web so that no additional actuation system or mechanism is required to hold or sever the web.

Furthermore, the web cut-off assembly may be an integrated assembly wherein the two arms are attached and move together to contact the web. An integrated assembly provides easy control of the mechanism to provide more consistent and effective breaking of the web. Prior attempts to provide a web cut-off assembly have included a single arm or multiple arms that moved separately. These web cut-off assemblies may fail to efficiently break a web, causing downtime on the machine.

One particular embodiment of a cut-off assembly 20 that is particularly well suited to breaking the web 4 while moving is shown in FIGS. 1-3. These figures illustrate the general principle of cut-off that occurs while the web and the corresponding cut-off device are in motion. In particular, the cut-off assembly 20 can form a break in a moving web 4 without having to stop or decelerate the web during the winding process. As shown, the cut-off assembly 20 is positioned over a conveying surface 14 transporting the moving web 4. Note that conveying surface 14 can be a flat plate, a moving conveyor, a curved surface or the surface of a roll moving at web speed. For moving surfaces, conveying surface 14 can be moving at web speed or a speed other than the web speed. The moving web is moving in the direction of the arrow represented by number 16. The conveying surface 14 can receive the web 4 from a parent roll or directly from a papermaking process.

The moving web 4 has at least one line of weakness 80 extending perpendicular to the direction in which the web is being conveyed. The term “line of weakness” refers to a continuous or discontinuous region of the web 4 possessing greater relative weakness to separate the tissue web into individual “sheets” which are detached from the roll by the user by tearing the tissue web along a line of weakness. Existing tissue converting equipment imparts perforations to the web by passing the tissue web through a nip between a stationary anvil and a rotating toothed blade. Either the anvil or the blade is skewed in the direction of travel to spread the impact of the blade against the anvil to reduce vibration while maintaining a cutting line perpendicular to the direction of sheet travel. As an example, a line of weakness 80 may suitably comprise a line of perforations, a plurality of separation points, a score line, a breakaway line or areas, a chain stitch or other suitable line of weakness. The web 4, however, can be perforated as it is unwound or can be pre-perforated upstream from the cut-off assembly.

The arms 26, 28 are connected in any way known to those skilled in the art so that the arms 26, 28 are movable relative to one another by providing a connection point with known bending properties, a hinge with a suitable mechanism to create the force required or two individual arms that are designed to work in concert with each other to trap and sever the web. Referring to the figures, the cut-off assembly 20 includes a first arm 26 connected via a pivot point 25 to a second arm 28 to enable movement of the arms. The first arm 26 includes a first web gripping surface 30 while the second arm 28 includes a second web gripping surface 32. Typically, the web gripping surfaces 30, 32 can be attached anywhere on the arms 26, 28 to facilitate the web gripping surfaces 30, 32 to make contact with the web. The arms 26, 28 are connected in any way known to those skilled in the art so that the arms 26, 28 are movable relative to one another and allow for the first and second web gripping surfaces 30, 32 to be movable relative to one another. In the embodiment illustrated in FIGS. 1-3, the first arm 26 and second arm 28 are connected by a hinge with known bending properties that define the pivot point 25.

When it is desirable to form a break in the web, the cut-off assembly 20 can be moved towards the conveying surface roll so that both web gripping surfaces 30, 32 contact the moving web on the conveying surface 14 at a first contact point 31 and a second contact point 33. As shown in FIG. 2, the web gripping surfaces 30, 32 can be designed to simultaneously contact the moving web 4 while on the conveying surface 14 at the contact points 31, 33. In order to move the arms 26 and 28 toward the conveying surface, the arms 26, 28 can be mounted onto a device that moves the assembly to the cut off location while generating the necessary driving force 50, such as an actuating cylinder. In order for the web to break in this embodiment, a pressure or force is applied to the cut-off assembly so that the arms 26, 28 rotate away from each other causing the web 4 to break at the line of weakness 80. In this manner, the first and second web gripping surfaces 30, 32 contact the moving web 4 at a first web gripping surface contact point 31 and a second web gripping surface contact point 33. The first and second web gripping surfaces contact points 31, 33 move from a first spaced apart relationship, D1, to a second spaced apart relationship, D2, causing a break in the web between the first and second web gripping surfaces contact points 31, 33. In this embodiment, the arms are spaced a set distance apart and the process is timed so that both web gripping surfaces contact points 31, 33 contact the web 4 when there is a perforation line, or line of weakness, located in between the two web gripping surfaces contact points 31, 33. In alternative embodiments, the arms 26, 28 are not spaced apart, but the web gripping surfaces contact points 31, 33 are spaced apart to enable contact with the web 4 when there is a line of weakness located in between the two web gripping surfaces contact points 31, 33.

The first spaced apart relationship, D1, or distance between the contact points 31, 33 at which the first web gripping surface 30 and the second web gripping surface 32 engage the web, can vary greatly depending upon the particular type of web material being conveyed and various other factors. For instance, in one embodiment, the web gripping surfaces contact points 31, 33 can be spaced in the first spaced apart relationship, D1, from about 0 cm to about 8 cm apart and more desirably from about 2.5 cm to about 5 cm apart. The spacing, for instance, allows for accuracy in placing a line of weakness in between the two web gripping surfaces contact points 31, 33 and reduces the strain length distance, resulting in less break failures. Shorter spacing requires more accuracy of phasing between the cut off assembly and the line of weakness, but shorter strain.

The web gripping surfaces 30, 32 typically have a high coefficient of friction allowing the surfaces to grip the web during the breaking process. The web gripping surfaces 30, 32 can be made from the same material or from different materials. In one embodiment, for instance, the second web gripping surface 32 can have the same coefficient of friction as the first web gripping surface 30. In other embodiments, it is desirable for the first web gripping surface 30 to hold onto the moving web 4 allowing for less grip of the web 4 along the second web gripping surface 32 downstream from the first web gripping surface 30 for breaking the web. In this embodiment, the second web gripping surface 32 can have a lower coefficient of friction than the first web gripping surface 30. Desirably, the web gripping surface coefficient of friction to the web may be greater than about 0.3, and more desirably between about 0.4 and 1.0.

Desirably, the conveying surface 14 may have a coefficient of friction to the web that is less than the coefficient of friction for the web gripping surfaces 30, 32. The conveying surface coefficient of friction may be less than about 0.5, more desirably between about 0.1 and 0.4. Note that the coefficient of friction between the conveying surface and the web is always lower than the coefficient of friction between the web gripping surface and the web.

The arms 26, 28 are illustrated in FIG. 2 in an engagement position for breaking the moving web 4 and forming a new leading edge. When the web 4 is being fed into the process, the cut-off assembly can be retracted away from the moving web so as to not interfere with the unwinding of the web from a parent roll. In particular, the arms 26, 28 may have a rest position just out of engagement with the moving web 4 as shown in FIG. 1.

When the web gripping surfaces 30, 32 engage the moving web, the first web gripping surface 30 and the second web gripping surface 32 desirably come into contact with the web at the contact points 31, 33 at approximately the same time. The cut-off assembly 20 contacts the moving web and provides a downward force that is placed on the sheet at the point of contact. As shown in FIG. 3, during the breaking process, a pressure or force is placed on the cut-off assembly causing the first arm 26 and second arm 28 to rotate apart. In this embodiment continuing to advance the web cut-off assembly closer to the moving web after initial contact with the moving web causes the arms 26, 28 to rotate apart. The web gripping surfaces 30, 32 create a frictional force perpendicular to the downward force. Since the coefficient of friction of the web gripping surfaces 30, 32 is greater than the coefficient of friction on the conveying surface 14, the cut-off assembly pulls apart the moving web 4 with sufficient force for the break to occur.

FIG. 4 illustrates an alternative embodiment of the cut-off assembly 40 for breaking a moving web 4. The moving web is moving in the direction of the arrow represented by number 56. Similar to above, the cut-off assembly 40 includes a first arm 46 connected via a pivot point 45 to a second arm 48 to enable movement of the arms. The first arm 46 includes a first web gripping surface 50 while the second arm 48 includes a second web gripping surface 52. Typically, the web gripping surfaces 50, 52 can be attached anywhere on the arms 46, 48 to facilitate the web gripping surfaces 40, 42 to make contact with the web. The web gripping surfaces 40, 42 make contact with the web at a first contact point 51 and a second contact point 53. In this embodiment, the arms 46, 48 are connected by a pivot point 45 in the middle portion of the arms 46, 48. A tension spring 58 connects the arms 46, 48 at the proximate end of the arms. When the web breaking event is to occur, a pressure or force is placed on the cut-off assembly causing the first arm 46 and second arm 48 to rotate apart. In this embodiment, continuing to advance the web cut-off assembly closer to the moving web after initial contact with the moving web, the cut-off assembly tension spring 56 expands moving the arms 46, 48 causing the first contact point 51 and second contact point 53 to move from a first spaced apart relationship, D1, to a second spaced apart relationship, D2, causing a break in the web. In this embodiment the shape of the contacting surface can be adjusted to provide less impact force at high operating speeds or to preferentially change the motion of the gripping pads as they are pressed towards the web.

FIG. 5 illustrates another alternative embodiment of the cut-off assembly 60 for breaking a moving web 4. The moving web is moving in the direction of the arrow represented by number 73. Similar to above, the cut-off assembly 60 includes a first arm 66 connected via a pivot point 65 to a second arm 68 to enable movement of the arms. The first arm 66 includes a first web gripping surface 70 while the second arm 68 includes a second web gripping surface 72. Typically, the web gripping surfaces 70, 72 can be attached anywhere on the arms 66, 68 to facilitate the web gripping surfaces 70, 72 to make contact with the web at a first contact point 71 and a second contact point 73. In this embodiment, the arms 66, 68 are again connected by a pivot point 65 in the middle portion of the arms 66, 68 and a tension spring 76 at the distal end of the arms. In this embodiment, the second arm 68 located further downstream on the process extends from the pivot point towards the moving web 4 farther than the first arm 66. During the web breaking event in this embodiment, as the cut-off assembly 60 pushes down on the conveying surface 14 with a downward force, the tension spring 76 expands causing the distal end of the second arm 68 to rotate away from the distal end of the first arm 66 holding its position causing the first contact point 71 and second contact point 73 to move from a first spaced apart relationship, D1, to a second spaced apart relationship, D2, causing a break in the web. The preferential movement of the second arm 68 enables the web breaking event to occur more naturally with the movement of the moving web 4. Different distances of movements of each arm allow matching speeds of the cut-off mechanism with curved web support surfaces or preferentially pushes one cut edge away while leaving the other cut edge undisturbed as it moves past the cut-off mechanism. For example it may be preferred not to disturb the trailing web side of the cut area, but have all the strain in the leading web side of the cut area.

FIG. 6 illustrates an alternative embodiment of the cut-off system 78 that can be included with any of the embodiments described above for breaking a moving web 4. The cut-off system includes the cut-off assembly 20 depicted in FIGS. 1-3 and a conveying surface 84. The moving web is moving in the direction of the arrow represented by number 93. In this embodiment, the conveying surface 84 has a first sliding support portion 81 and a second sliding support portion 82. The two sliding support portions, 81, 82 are connected by a tension spring 86. Note that a tension spring, cam operated slide, actuator or other mechanisms known in the art can be used to move the two sliding supports. When the cut-off assembly 78 has contacted and begins to push on the moving web 4, the moving web 4 is pinched between the conveying surface 84 and the cut-off assembly 20. The downward force on the cut-off assembly 20 as it continues to move towards the conveying surface causes the tension spring 86 to expand and the first sliding support portion 81 to move away from the second sliding support portion 82, as illustrated in FIG. 7, simultaneous with the movement of the arms 26, 28 of the cut-off assembly 20. This greatly reduces the force required to sever the sheet because the effective force has been greatly reduced between the web and the conveying surface. The tension spring retracts back when the cut-off assembly 20 is lifted away from the conveying surface to allow for the moving web 4 to move along the conveying surface 84.

FIG. 8 illustrates a center rewinder 100 with a turret assembly 110 that may be employed using the cut-off assembly 20 disclosed herein. Turret assemblies are well known to those skilled in the art to be useful for winding paper onto a core. In general, turret assemblies often include at least one mandrel that is rotatably affixed to an indexing mechanism. The indexing mechanism, or turret, can rotate a mandrel into a number of positions or “stations” at which various steps of the winding process can occur. For instance, at one position, the moving web can be attached to the mandrel. At another position, the moving web can be wound around the mandrel. And, at yet another position, the wound rolled product can be removed from the mandrel. Any turret assembly known to those skilled in the art is suitable for use in the present invention. Examples of various turret assemblies that can be used in the present invention include, but are not limited to, the turret assemblies described in U.S. Pat. No. 4,133,495 to Dowd; U.S. Pat. No. 5,337,968 to De Bin et al.; and U.S. Pat. No. 5,797,559 to Coffey, which are incorporated in their entirety herein by reference.

In this embodiment, a bedroll 102 defines a conveying surface 14 of the web cut-off system 100. In an exemplary embodiment, the bedroll 102 rotating in the direction of the arrow represented by arrow 103 may also be a vacuum transfer roll utilized to hold the moving web 4 on the conveying surface 14 of the rotating roll 102. The moving web is moving in the direction of the arrow represented by number 103. A rotating web cut-off roll 19 is rotatably mounted in proximity to the bedroll 102 and rotating in the direction of the arrow represented by number 105 to allow for the web cut-off roll 19 to contact or engage the conveying surface 14. Mounted within the web cut-off roll 19 is the cut-off assembly 20. When the web 4 is being fed into the process, the cut-off assembly 20 can be retracted radially within the web cut-off roll 19 so as to not interfere with the unwinding of the moving web 4 from a parent roll. The cut-off assembly 20 includes an actuating cylinder 111 to radially move the web cut-off assembly within the web cut-off roll to contact the moving web and cause the first web gripping surface 30 and the second web gripping surface 32 to contact the moving web 4 simultaneously when a web break is desired.

The turret assembly 110 is rotatably mounted below the bedroll 102 and rotating in the direction of the arrow represented by number 107. The turret assembly 110 further includes a plurality of rotating mandrels such as winding position mandrel 112 where paper is wound upon a core 108. The winding process can be initiated by first placing a core 108 onto mandrel according to any method known in the art, defined as the “core loading position,” which is the position occupied by mandrel 113. Once the core 108 is placed onto mandrel 113, the turret assembly 110 can then be indexed into an “adhesive application position,” which is the position occupied by mandrel 114. In particular, an adhesive can be applied by any method known in the art to core 108. Generally, an adhesive used can comprise any of a variety of materials, such as glue, known to adhere paper to a surface. Although not necessarily required, such an adhesive facilitates attachment of the paper web onto a core.

Once adhesive or other attachment means is applied to core 108, the mandrel can be indexed by turret 110 into the “pre-spin position,” which is the position occupied by mandrel 116. At the “pre-spin position,” the mandrel can be rotated to ensure that the mandrel achieves a certain rotational speed before a paper web is wound thereon. Once initially rotated at the “pre-spin position,” the mandrel can then be indexed by turret assembly 110 into the “transfer/winding position,” which is the position occupied by mandrel 112. A transfer pusher device 127 may be used to move the moving web 4 from the bedroll 102 to the turret assembly 110. The transfer pusher device 127 can be mounted onto a bearing and driven by any suitable driving device 129, such as an actuating cylinder as is illustrated in FIG. 8.

The rotational speed of the mandrel imparted at the “pre-spin position,” is generally greater than the feed speed of the paper web such that, as the rotating mandrel is indexed into the “winding position,” the paper web can wind around the mandrel. Moreover, mandrel 112, for example, can be further rotated in a clockwise direction, while in the “winding position”, such that moving web 4 can be wound thereon. In some embodiments, the rotational speed of mandrel 112 is controlled to provide a substantially constant rate from the time it first contacts the leading edge of paper web 4 until the end of the winding period. As the winding of the web is completed, the web cut-off assembly 20 acts to break the moving web to create a new rolled product.

After the moving web 4 is wound onto the mandrel, it can then be further indexed by turret 110 into a “tail seal position,” which is the position occupied by mandrel 118. At the “tail seal position,” the unattached portions of web 4 can be sealed to the roll of paper via a sealing device (not shown). In some embodiments, for example, the sealing device can be configured to apply glue or some other adhesive to the paper web such that the tail can be sealed thereto. An external roll (not shown) can also be used for rotating mandrel 118 at the “tail seal position” of this embodiment. As such, mandrel 118 can rotate at a slower speed, which can aid in the sealing process.

Once sealed, the finished rolled product can then be removed. In some embodiments, the mandrel containing a finished roll of paper can be indexed by turret 110 into a “removal position,” which is the position occupied by mandrel 120. A finished roll product can be axially removed from mandrel 120 by any method known in the art.

In an alternative embodiment as depicted in FIG. 9, the cut-off assembly 20 may be used with a surface winder 200, as described in U.S. Pat. No. 5,769,352 to Biagiotti herein incorporated by reference. The surface winder includes a first winding roll 210 rotating in the direction of the arrow represented by number 221, a second winding roll 213 rotating in the direction of the arrow represented by number 229, a nip 215 defined between the two winding rolls, through which the moving web 4 is fed, and a core support 212, which extends upstream of the nip 5 in relation to the direction of feed of the web material 4.

Defined between the first winding roll 210 and the core support 212 is an open area 233 for feeding the winding cores. The dimension in height of the open area 233, which is the distance between the core support 212 and the cylindrical surface of the first winding roll 210, is more or less equal or slightly smaller than the diameter of the winding cores, which when inside the channel are in contact with both of these elements. Moreover, a third winding roll 219 rotating in the direction of arrow represented by 225 is provided to complete winding the finished product in cooperation with the first winding roll 210 and the second winding roll 213.

A feeder 216 may be provided to feed the winding cores into the open area 233. In the example illustrated, the feeder 216 includes a conveyor 218 along which pushers 220 are disposed. The conveyor 218 may pass through a glue dispenser (not shown) to apply a glue to the surface of the cores.

Upstream (in relation to the direction of feed of the web material) of the nip 215 defined between the core support 212 and the first winding roll 210 is a web cut-off roll 222 with the cut-off assembly 20. The web cut-off roll 222 is positioned to sever the moving web 4 at the end of winding a finished rolled product. A slot 235 in the core support allows the cut-off assembly to be able to access the moving web 4. The rotating web cut-off roll 222 is rotatably mounted in proximity to the first winding roll 210 to allow for the web cut-off roll 222 to contact or engage the moving web 4. Mounted within the web cut-off roll 222 is the cut-off assembly 20. The radius of curvature of the supporting roll 221 provides a natural compression of the cut-off assembly 20 and helps to sever the web. When the web 4 is being fed into the process, the cut-off assembly 222 can be retracted radially within the web cut-off roll 222 so as to not interfere with the unwinding of the moving web 4 from a parent roll. The cut-off assembly 20 includes an actuating cylinder to radially move the web cut-off assembly within the web cut-off roll 226 to contact the moving web 4 and causing the first web gripping surface 30 and the second web gripping surface 32 to contact the moving web 4 simultaneously. The action of the cut-off assembly tears the web material at a point between the open area 233 and the completed log, being unloaded from the winding cradle formed by the winding rolls 210, 213, 219.

When a finished product is completely formed, the cut-off assembly 20 acts upstream of the nip 215. This cut-off assembly 20 rotates in the direction of arrow represented by 223 and enters the core support through the slot 235 with a variable speed controlled by a programmable control unit (not shown) to act synchronously with the other elements of the machine.

The first winding roll 210 may be a vacuum roll. Use of a vacuum roll produces suction on the surface of the first winding roll 210 causing the initial and final edges of the web material produced by tearing to adhere to the first winding roll 210.

The feeder 216 pushes a new core 208 to the inlet of the open area. Synchronism between the cut-off assembly 20 and the action of the feeder 216 makes the core 208 rest against the surface of the first roll 210 at the inlet of the open area when the final edge and the initial edge of the web material obtained by tearing have already moved beyond the inlet of the open area defined by the core support 212. The initial edge of the new rolled product ceases to adhere to the first winding roll 210 when the moving web 4 adheres to the core 208. Glue may be applied to the core to hold the moving web 4 in order to start forming a new rolled product. Alternatively other arrangements may be used to cause winding to commence. For example, the core may be provided with suction, or electrostatically charged, or yet again nozzles may be provided to redirect the initial edge of the web material so that it clings to the new core to form a first turn of the winding.

Driven by contact with the first winding roll 210 and with the core support 212, the new core with the web material that starts to wind around it travels along the open area rolling on the core support 212 at a speed that is half the peripheral speed of the first winding roll 210. The winding mandrel travels through the nip 215 and enters the actual winding cradle 240, formed by the winding rolls 210, 213, 219 and where winding of the finished product is completed. Once forming of the finished product has been completed the cut-off assembly 20 acts again to allow the finished product to continue along the production line.

Other modifications and variations to the appended claims may be practiced by those of ordinary skill in the art, without departing from the spirit and scope as set forth in the appended claims. It is understood that features of the various examples may be interchanged in whole or in part. The preceding description, given by way of example in order to enable one of ordinary skill in the art to practice the claimed invention, is not to be construed as limiting the scope of the invention, which is defined by the claims and all equivalents thereto.

What is claimed is:

1. A method of breaking a moving web comprising:
conveying a moving web on a conveying surface, contacting the moving web with a web cut-off assembly, the web cut-off assembly comprising a first arm with a first web gripping surface and a second arm with a second web gripping surface, the first web gripping surface contacting the web at a first contact point and a second arm with a second web gripping surface contacting the web at a second contact point, the first contact point and the second contact point in a first spaced apart relationship, wherein the at least one line of weakness is located between the first contact point and second contact point; and
moving the first contact point and the second contact point from the first spaced apart relationship to a second spaced apart relationship causing a break in the web between the first and second contact points.

2. The method of claim 1 wherein the moving web has at least one line of weakness extending perpendicular to the direction in which the web is being conveyed.

3. The method of claim 1 wherein the conveying surface comprises a roll that rotates with the moving web.

4. The method of claim 1 wherein the conveying surface comprises a vacuum roll that holds a moving web onto the conveying surface.

5. The method of claim 1 wherein the conveying surface is a conveyor belt.

6. The method of claim 5 wherein the conveyor is a vacuum conveyor.

7. The method of claim 1 wherein the distance between the first and second contact points in the first spaced apart relationship is less than about 8 cm.

8. The method of claim 1 wherein the distance between the first and second contact points in the first spaced apart relationship is from about 2.5 cm to about 5 cm.

9. The method of claim 1 wherein first and second web gripping surfaces have a gripping surface coefficient of friction greater than a conveying surface coefficient of friction.

10. The method of claim 1 wherein the web cut-off assembly is an integrated assembly and further comprising moving the web cut-off assembly towards the moving web and causing the first web gripping surface and the second web gripping surface to contact the moving web simultaneously.

11. The method of claim 1 further comprising applying a force to the web cut-off assembly causing the first arm and second arm to rotate and move the first web gripping surface and the second web gripping surface from the first spaced apart relationship to the second spaced apart relationship.

12. The method of claim 1 wherein the conveying surface further comprises a first sliding support portion and a second sliding support portion, the first sliding support portion and the second sliding support portion movable relative to each other, wherein the first sliding support portion and the second sliding support portion move away from each other when the cut-off assembly contacts the moving web.

13. The method of claim 1 wherein moving the first and second contact arms relative to one another comprises continuing to advance the web cut-off assembly closer to the moving web after initial contact with the moving web.

14. The method of claim 1 wherein the first and second arms are pivotally mounted; and wherein moving the first and second contact arms relative to one another comprises pivoting the first and second arms relative to one another.

15. A web cut-off system comprising:
a conveying surface over which a moving web is conveyed;
a web cut-off roll rotatably mounted opposing the conveying surface;
a web cut-off assembly disposed on the web cut-off roll, the web cut-off assembly comprising a first arm with a first web gripping surface and a second arm with a second web gripping surface, the first web gripping surface contacting the web at a first contact point and a second arm with a second web gripping surface contacting the web at a second contact point, the first contact point and the second contact point in a first spaced apart relationship, wherein the at least one line of weakness is located between the first contact point and second contact point; and
moving the first contact point and the second contact point from the first spaced apart relationship to a second spaced apart relationship causing a break in the web between the first and second surfaces.

16. The cut-off system of claim 15 wherein the conveying surface comprises a bedroll that rotates with the moving web.

17. The cut-off system of claim 15 wherein the conveying surface comprises a vacuum roll that holds a moving web onto the conveying surface.

18. The cut-off system of claim 15 wherein the conveying surface is a conveyor belt.

19. The cut-off system of claim 15 wherein the conveyor is a vacuum conveyor.

20. The cut-off system of claim 15 wherein the distance between the first and second contact points in the first spaced apart relationship is from about 2.5 cm to about 5 cm.

21. The cut-off system of claim 15 wherein first and second web gripping surfaces have a gripping surface coefficient of friction greater than a conveying surface coefficient of friction.

22. The cut-off system of claim 15 wherein the conveying surface further comprises a first sliding support portion and a second sliding support portion, the first sliding support portion and the second sliding support portion movable relative to each other, wherein the first sliding support portion and the second sliding support portion move away from each other when the cut-off assembly contacts the moving web.

23. The cut-off system of claim 15 further comprising radially moving the web cut-off assembly within the web cut-off roll to contact the moving web and causing the first web gripping surface and the second web gripping surface to contact the moving web simultaneously.

24. A short strain length web cut-off assembly comprising:
a bedroll disposed such that web material from a parent roll passes around a circumferential surface portion of said bedroll;
a web cut-off roll rotatably mounted opposing the bedroll;
a web cut-off roll assembly including a pair of web gripping surfaces retractably mounted within the web cut-off roll, the web gripping surfaces moveable from a retracted position to a protracted position radially beyond the web cut-off roll to engage the web material for a web cutting event; wherein the web cutting event consists of the pair of web gripping surfaces contacting the moving web causing the pair of web gripping surfaces to move from a first spaced apart relationship to a second spaced apart relationship thereby causing a break in the web.

25. The cut-off assembly of claim 24 wherein a distance between the first and second contact points in the first spaced apart relationship is less than about 8 cm.

26. The cut-off assembly of claim 24 wherein a distance between the first and second contact points in the first spaced apart relationship is from about 2.5 cm to about 5 cm.

27. The cut-off assembly of claim 24 wherein first and second web gripping surfaces have a gripping surface coefficient of friction greater than a conveying surface coefficient of friction.

28. The cut-off assembly of claim 24 wherein first and second web gripping surfaces have a gripping surface coefficient of friction greater than a conveying surface coefficient of friction.
